(19) United States
(12) Patent Application Publication
(10) Pub. No.: US 2008/0190325 A1
(43) Pub. Date: Aug. 14, 2008

(54) Modified Nanoparticles

(75) Inventors: Karl Kohler, Diekholzen (DE); Ferdinand Hardinghaus, Bad Honnef (DE); Jai-Won Park, Gottingen (DE); Ulrich Seseke-Koyro, Isernhagen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: SOLVAY INFRA BAD HOENINGEN GMBH, Honnover (DE)

(21) Appl. No.: 11/916,353

(22) PCT Filed: Jun. 2, 2006
(86) PCT No.: PCT/EP2006/062860

§ 371 Date: Dec. 3, 2007

(30) Foreign Application Priority Data
Jun. 4, 2005 (DE) 10 2005 025 721.6
Oct. 5, 2005 (DE) 10 2005 047 807.7

(51) Int. Cl. C04B 14/02; B32B 5/16

(52) U.S. Cl. 106/499; 428/403; 428/407

(57) ABSTRACT

The invention discloses nanoparticles which have preferably a particle size of less than 100 nm, have been coated with a dispersant, and optionally further comprise a crystallization inhibitor. Preferred dispersants are those which endow the nanoparticles with a hydrophilic or hydrophobic surface and contain reactive groups for coupling to or into polymers. Also disclosed are plastics comprising nanoparticles of this kind.

The present invention relates to modified nanoparticles, their preparation and use.

International patent application WO 00/57932 discloses materials for surgical application that contain what it refers to as nanocomposites. The filler particles, which absorb X-rays, and of which examples include barium sulphate, titanium oxide, zirconium oxide and chromium oxide, can be treated with organic compounds in order to enhance their dispersibility, to reduce their propensity to agglomerate or aggregate and to enhance the uniformity of the dispersion. Examples of compounds employed for this purpose include organic compounds such as the monomer of the surgical material under production, citrates or other compounds. Use may also be made of coupling agents such as organosilanes or of polymeric materials such as surfactants, an example being sodium dodecyl sulphate, but also of amphiphilic molecules, i.e. molecules which have a hydrophilic part and a hydrophobic part. Those specified include nonylphenol ethoxylates; bis(2-ethylhexyl)sulphosuccinate; hexadecyltrimethylammonium bromide; and phospholipids. The examples use either uncoated barium sulphate or particles coated post precipitation with sodium citrate.

One of the objects of the present invention was to specify finely divided nanoparticles which are redispersible even after drying, especially nanoparticles which lend themselves well to incorporation into plastics. A particular object was to provide deagglomerated nanoparticles which, especially when incorporated into plastic, do not undergo reagglomeration. These and further objects are achieved by means of the present invention.

The invention provides inorganic nanoparticles coated with a dispersant and if desired additionally containing a crystallization inhibitor, said nanoparticles having an average particle size <500 nm, preferably <250 nm, very preferably <100 nm, in particular <80 nm, with particular preference <50 nm, with especial preference <20 nm, with very particular preference <10 nm, with the exception of barium sulphate particles, as disclosed in international patent application PCT/EP04/013612, unpublished at the priority date of the present specification.

The lower limit to the average primary particle size is 5 nm for example but may be even lower, down to 1 nm. These are average particle sizes as determined by XRD or laser diffraction methods.

The amount of crystallization inhibitor and dispersant in the nanoscale particles is flexible. Per part by weight of nanoparticles it is possible for there to be up to 2 parts by weight, preferably up to 1 part by weight, of crystallization-inhibiting dispersant. Where a crystallization inhibitor is present, it too is present in an amount of up to 2 parts by weight per part by weight of nanoparticles, preferably up to 1 part by weight per part by weight of nanoparticles. The dispersant is present preferably in an amount of 1 to 50% by weight in the nanoparticles, the sum of nanoparticles and dispersant and also, where present crystallization inhibitor being 100% by weight. Where a crystallization inhibitor is present, as well, it is present preferably in an amount of 1% to 50% by weight in the nanoparticles, the sum of nanoparticles and dispersant and also, where present, crystallization inhibitor being 100% by weight. The sum of crystallization inhibitor and dispersant is preferably not greater than 80% by weight of the total weight of the nanoparticles. The nanoparticles are preferably present in an amount of 20% to 99% by weight, the sum of nanoparticles and dispersant and also, where present, crystallization inhibitor being 100% by weight.

The crystallization inhibitor, where employed, is intended to prevent the formation of larger crystal particles as a result of crystal growth when the inorganic nanoparticles are precipitated or in the course of their further processing, with the consequence that the nanometre range is departed.

The dispersant is intended to ensure that the nanoparticles are readily dispersible, in solvents, plastics, polymeric premixes, etc.

It is known that certain inorganic particles, in the course of their conventional preparation without the addition of crystallization inhibitors or dispersants can form agglomerates (secondary particles) made up of primary particles. The term “deagglomerates” in this context does not mean that the secondary particles have been broken down completely into primary particles which exist in isolation. It means that the secondary particles are not in the same agglomerated state in which they are typically produced in precipitations, but instead are in the form of smaller agglomerates. The deagglomerated nanoparticles of the invention preferably contain agglomerates (secondary particles) at least 90% of which having an average particle size of less than 2 μm, preferably less than 1 μm. With particular preference the average particle size is less than 250 nm, with very particular preference less than 200 nm. More preferably still, it is less than 130 nm, with particular preference less than 100 nm, with very particular preference less than 80 nm; more preferably still, the secondary particles have an average particle size of <50 nm, or even <30 nm. In part or even in substantial entirety the nanoparticles are in the form of unagglomerated primary particles. These are average particle sizes as determined by means of XRD or laser diffraction methods.

The following text describes crystallization inhibitors which can be used in the present invention. Preferred crystallization inhibitors contain at least one anionic group. The anionic group in the crystallization inhibitor is preferably at least one sulphate, at least one sulphonate, at least two phosphate, at least two phosphonate or at least two carboxylate group(s).

Crystallization inhibitors present may be, for example substances that are known to be used for this purpose, examples being relatively short-chain or else longer-chain polyacrylates, typically in the form of the sodium salt; polyethers such as polyglycol ethers; ether sulphonates such as lauryl ether sulphonate in the form of the sodium salt; esters of phthalic acid and of its derivatives; esters of polyglycerol; amines such as triethanol amine; and esters of fatty acids, such as stearic esters, as specified in WO 01/92157.

As the crystallization inhibitor it is also possible to use a compound of formula (I) or a salt thereof having a carbon chain R and n substituents [A(O)OH],

R [-A(O)OH]ₙ (I)

in which

R is an organic radical which has hydrophobic and/or hydrophilic moieties, R being a low molecular mass, oligomeric or polymeric, optionally branched and/or cyclic carbon chain which optionally contains oxygen, nitrogen, phosphorus or sulphur heteroatoms and/or is substituted by radicals which are attached via oxygen, nitrogen, phosphorus or sulphur to the radical R, and

A being C, P(OH), OP(OH), S(O) or OS(O), and n being 1 to 10 000.

In the case of monomeric or oligomeric compounds, n is preferably 1 to 5.

Useful crystallization inhibitors of this kind include hydroxy-substituted carboxylic acid compounds. Highly useful examples are hydroxy-substituted monocarboxylic and dicarboxylic acids. Such carboxylic acids preferably have 1 to 20 carbon atoms in the chain (reckoned without the carbon atoms of the COO groups), such as citric acid, malic acid (2-hydroxybutane-1,4-dioic acid), dihydroxysuccinic acid and 2-hydroxyoleic acid, for example. Very particular preference is given to citric acid and polyacrylate as crystallization inhibitor.

Also very useful are phosphonic acid compounds having an alkyl (or alkylene) radical with a chain length of 1 to 10 carbon atoms. Highly useful compounds in this context are those containing one, two or more phosphonic acid radicals. They may additionally be substituted by hydroxyl groups. Highly useful examples include 1-hydroxyethylenediphosphonic acid, 1,1-diphosphonopropane-2,3-dicarboxylic acid and 2-phosphonobutane-1,2,4-tricarboxylic acid. These examples show that compounds containing not only phosphonic acid radicals but also carboxylic acid radicals are likewise useful.

Also very useful are compounds which contain 1 to 5 or an even greater number of nitrogen atoms, and also 1 or more, for example up to 5 carboxylic acid or phosphonic acid radicals and which are optionally substituted additionally by hydroxyl groups. These include, for example, compounds having an ethylenediamine or diethylenetriamine framework and carboxylic acid or phosphonic acid substituents. Examples of highly useful compounds are diethylenetriaminepentakis(methanephosphonic acid), iminodisuccinic acid, diethylenetriaminepentaacetic acid and N-(2-hydroxyethyl)ethylenediamine-N,N,N-triacetic acid.

Also very useful are polyamino acids, an example being polyaspartic acid.

Also very useful are sulphur-substituted carboxylic acids having 1 to 20 carbon atoms (reckoned without the carbon atoms of the COO group) and 1 or more carboxylic acid radicals, an example being sulphosuccinic acid bis-2-ethylhexyl ester (dioctyl sulphosuccinate).

The crystallization inhibitor is preferably an optionally hydroxy-substituted carboxylic acid having at least two carboxylate groups; an alkyl sulphate; an alkylbenzenesulphonate; a polyacrylic acid; a polyaspartic acid; an optionally hydroxy-substituted diphosphonic acid ethylenediamine or diethylenetriamine derivatives containing at least one carboxylic acid or phosphonic acid and optionally substituted by hydroxyl groups; or salts thereof.

It is of course also possible to use mixtures of the additives, including mixtures, for example, with further additives such as phosphorous acid

The preparation of the nanoparticles comprising crystallization inhibitors, particularly those of the formula (I), is advantageously carried out by precipitating the nanoparticles in the presence of the envisaged crystallization inhibitor. It can be advantageous if at least part of the inhibitor is deprotonated; for example, by using the inhibitor at least in part, or entirely, as an alkali metal salt, a sodium salt, for example or as an ammonium salt. Naturally, it is also possible to use the acid and to add a corresponding amount of the base, or in the form of an alkali metal hydroxide solution.

The nanoparticles comprise not only the optional crystallization inhibitor but also an agent which has a dispersing action. This dispersant prevents the formation of undesirably large agglomerates. It can be added during the actual precipitation of the nanoparticles. As will be described later on below, it can also be added in a subsequent deagglomeration stage; it prevents reagglomeration and ensures that agglomerates are readily redispersible.

Dispersants typically have a hydrophilic moiety and a hydrophobic moiety in their molecule. Preferably the dispersant contains one or more anionic groups which are able to interact with the surface of the nanoparticles. Such anionic groups will act as anchor groups for the surface of the barium sulphate particles. Preferred groups are the carboxylate group, the phosphate group, the phosphonate group, the bisphosphonate group, the sulphate group and the sulphonate group.

Dispersants which can be used include some of the above-mentioned agents which as well as a crystallization inhibitor effect also have a dispersing effect. When agents of this kind are used, it is possible for crystallization inhibitor and dispersant to be identical. Suitable agents can be determined by means of routine tests. The consequence of agents of this kind with a crystallization inhibitor effect and dispersing effect is that the nanoparticles are obtained in particularly small primary particles and form readily redispersible agglomerates. Where an agent of this kind having both crystallization inhibitor effect and dispersing effect is used, it may be added during the precipitation and, if desired, deagglomeration may additionally be carried out in its presence.

It is usual and preferred to use different compounds having crystallization inhibitor effect and dispersing effect respectively.

Very advantageous nanoparticles are those comprising dispersants of a kind which endow the nanoparticles with a surface which prevents reagglomeration and/or inhibits agglomeration electrostatically, sterically or both electrostatically and sterically. Where such a dispersant is present during the actual precipitation, it inhibits the agglomeration of the nanoparticles, so that deagglomerated nanoparticles are obtained even at the precipitation stage. Where such a dispersant is incorporated after the precipitation, as part of a wet-grinding operation, for example, it prevents the reagglomeration of the nanoparticles after deagglomeration. Nanoparticles comprising a dispersant of this kind are especially preferred on account of the fact that they remain in the deagglomerated state.

Particularly advantageous deagglomerated nanoparticles—which where appropriate may also comprise crystallization inhibitors as well—are characterized in that the dispersant contains carboxylate, phosphate, phosphonate, bisphosphonate, sulphate or sulphonate groups which are able to interact with the surface of the nanoparticles (anchor group for the surface of the barium sulphate particles), and in that it contains one or more organic radicals R1 which contain hydrophobic and/or hydrophilic moieties.

Preferably R1 is a low molecular mass, oligomeric or polymeric, optionally branched and/or cyclic carbon chain which optionally contains oxygen, nitrogen, phosphorus or sulphur heteroatoms and/or is substituted by radicals which are attached via oxygen, nitrogen, phosphorus or sulphur to the radical R1 and the carbon chain is optionally substituted by hydrophilic or hydrophobic radicals. One example of substituent radicals of this kind are polyether or polyester based side chains.

Preferred polyether based side chains have 3 to 50, preferably 3 to 40 in particular 3 to 30 alkyleneoxy groups. The alkyleneoxy groups are preferably selected from the group consisting of methyleneoxy, ethyleneoxy, propyleneoxy and butyleneoxy groups. The length of the polyether based side chains is generally from 3 to 100 nm, preferably from 10 to 80 nm.

Preferred nanoparticles of the invention comprise a dispersant which contains groups for coupling to or into polymers. Such groups will act as anchor groups for the polymer matrix. These may be groups which bring about this coupling chemically, examples being OH, NH, NH₂, SH, O—O peroxo, C—C double bond or 4-oxybenzonphenone propylphosphonate groups. The groups in question may also be groups which bring about physical coupling.

An example of a dispersant which renders the surface of the nanoparticles hydrophobic is represented by phosphoric acid derivates in which one oxygen atom of the P(O) group is substituted by a C3-C10 alkyl or alkenyl radical and a further oxygen atom of the P(O) group is substituted by a polyether side chain. A further acidic oxygen atom of the P(O) group is able to interreact with the surface of the nanoparticles.

The dispersant may be, for example a phosphoric diester having a polyether or a polyester based side chain and a C6-C10 alkenyl group as moieties. Phosphoric esters with polyether/polyester side chains such as Disperbyk®111, phosphoric ester salts with polyether/alkyl side chains such as Disperbyk®102 and 106, substances having a deflocculating effect, based for example on high molecular mass copolymers with groups possessing pigment affinity, such as Disperbyk®190 or polar acidic esters of long-chain alcohols, such as Disperplast®140 are further highly useful types of dispersants.

Nanoparticles having especially good properties comprise as their dispersant a polymer which contains anionic groups that are able to interact with the surface of the nanoparticles (anchor groups for the surface of the barium sulphate particles), examples being the groups specified above, and which contains groups for coupling to or into polymers, such as OH, NH, NH₂, SH, O—O peroxo, C—C double bond or 4-oxybenzonphenone propylphosphonate groups (anchor groups for the polymer matrix). Preferably there are polyether or polyester based side chains present which contain OH, NH, NH₂, SH, O—O peroxo, C—C double bond or 4-oxybenzonphenone propylphosphonate groups. Nanoparticles of this kind exhibit no propensity to reagglomerate. During the application, as for example when they are incorporated into plastics or polymeric premixes, there may even be further deagglomeration.

As a result of the substitution with polar groups, especially hydroxyl groups and amino groups, the nanoparticles are externally hydrophilicized.

Preferred dispersants contain at least one anionic group which will act as an anchor group for the surface of the barium sulphate particles, at least one polyether or polyester based side chain that prevents reagglomeration sterically, and at least one group which will act as an anchor group for the polymer matrix.

The groups used for coupling to or into polymers can be preferentially selected with regard to the nature of the polymer matrix. The polar groups, especially hydroxyl groups and amino groups, represent reactive groups which are suitable for coupling to or into epoxy resins in particular. Especially good properties are exhibited by nanoparticles coated with a dispersant which contains a multiplicity of polycarboxylate groups and a multiplicity of hydroxyl groups and which also has further substituents which are sterically bulky, examples being polyether or polyester based chains. A very preferred group of dispersants, notably for nanoparticles used as fillers in epoxy resins, are polyether polycarboxylates substituted terminally on the polyether based side chains by hydroxyl groups. Hydroxyl groups are also notably suitable for coupling to or into polyurethanes. Hydroxyl groups and thiol groups can be used for coupling to or into polyvinylchloride (PVC). Another example is 4-oxybenzophenone propylphosphonate which can be used for coupling to or into polyolefines or PVC. O—O peroxo groups are useful anchor groups for unsaturated polyester or polyolefines. After admixture of the barium sulphate containing the dispersant to the resin, the reaction between the peroxo group and the resin is initiated. A further example is the use of C—C double bond for coupling to or into unsaturated polyesters.

Nanoparticles which optionally comprise a crystal growth inhibitor and one of the particularly preferred dispersants that prevents reagglomeration sterically, especially a dispersant substituted by anchor groups for the polymer matrix as described above, have the great advantage that they comprise very fine primary particles and comprise secondary particles whose degree of agglomeration is low at most; these particles, since they are readily redispersible, have very good application properties—for example, they can be incorporated readily into polymers and do not tend towards reagglomeration, and, indeed, undergo further deagglomeration in the course of the application.

In accordance with one embodiment the deagglomerated, dispersant-coated nanoparticles are in dry form, in other words free from solvent(s). In accordance with a further embodiment, they are in the form of a dispersion in water or in the form of a dispersion in an organic liquid, it being possible for the organic liquid optionally to contain water as well. Preferred organic liquids are alcohols, such as isopropanol or mixtures thereof with other alcohols or polyols, ketones such as acetone, cyclopentanone or methyl ethyl ketone, naphtha or special boiling point spirit, and mixtures thereof, halogenated aromatic and especially aliphatic hydrocarbons such as chlorocarbons, hydrochlorocarbons, methylene chloride, for example, fluorocarbons, hydrofluorocarbons, chlorofluorocarbons and hydrochlorofluorocarbons. Additives, examples being plasticizers such as dioctyl phthalate or diisodecyl phthalate, can be admixed. Within the dispersion the dispersed nanoparticles are present preferably in an amount of 0.1% to 70% by weight, with particular preference 0.1% to 60% by weight, for example 0.1% to 25% by weight or 1% to 20% by weight.

The nanoparticles, and especially the dispersion, particularly when it is on an aqueous basis, may further comprise modifiers which influence their properties, examples being agents which stabilize the dispersion.

Product of the invention also includes nanoparticles with an average primary particle size <50 nm, preferably <20 nm, which is in substantially agglomerate-free form, and hence in which the average secondary particle size is not more than 30% greater than the average primary particle size.

The invention provides a number of variants for making deagglomerated nanoparticles of the invention available.

Where a crystallization inhibitor is to be present it is most advantageous to convert the nanoparticles into solid form in the presence of the crystallization inhibitor, for example by a precipitation reaction crystallization from a solution or by drying from a gel. A crystallization inhibitor may be advantageous in order to inhibit crystal growth. As a result, smaller particles are obtained even at the precipitation stage.

The dispersant can be added to the nanoparticles in a variety of ways. In general it can be added to the nanoparticles after they have been formed, by means of an intense comminuting operation in the presence of the dispersant, or as early as during the formation of the nanoparticles, such as when the nanoparticles are precipitated, for example, by combining metal salts soluble in water, for example, with solutions of compounds of anions which together with the metal form a solid which is of low or zero solubility in the solvent used; or by crystallization from solutions of the desired compounds; or by drying of gels. The chemical compounds corresponding to the nanoparticles can therefore be converted into a solid form in the presence of the dispersant, preferably by precipitation, and/or the chemical compounds corresponding to the nanoparticles, present in particulate form as particles larger than desired, are subjected to an intensive comminuting operation in the presence of the dispersant. Where additionally a crystallization inhibitor is to be used, the nanoparticles are advantageously formed in the presence of crystallization inhibitor and dispersant. The presence of dispersant reduces or eliminates the propensity of certain compounds to form agglomerates, i.e. secondary particles from the primary particles. The dispersant can, if desired, be added when the solid particles are produced and additionally in a subsequent comminution step.

The first embodiment is now elucidated in more detail. The nanoparticles are produced by the customary methods. This may take place by means of customary methods such as precipitation. The production of solids by precipitation is a known process. For example, solutions containing the cation and the anion are combined. Then the solvent is removed and the solid recovered. It is also possible to react solids or suspensions with liquids—for example, solid carbonates, metal oxides or metal hydroxides with the corresponding acids—in order to generate the desired salts. Sulphates, phosphates or fluorides can be prepared, for example, from the carbonates, oxides, hydroxides or solutions thereof with corresponding acids such as sulphuric acid, phosphoric acid or hydrochloric acid; carbonates can be prepared by reaction of metal salts and carbonate or CO₂. Strontium sulphate is prepared by, for example reacting strontium chloride with alkali metal sulphate or sulphuric acid; calcium carbonate by reacting calcium hydroxide with carbon dioxide; calcium fluoride or magnesium fluoride by reaction of calcium chloride, calcium carbonate or calcium hydroxide or the corresponding magnesium compounds with alkali metal fluoride or hydrochloric acid. The reaction may take place, for example, in dissolvers. In a similar way, corresponding compounds with other metals are prepared. The oxidic compounds can be generated by dehydration of the hydroxides. Solids recovery is also possible through crystallization from a saturated solution, by formation of a gel with subsequent drying, etc. In the course of the precipitation or crystallization it is possible to use additives which inhibit crystal growth, examples being those as specified in WO 01/92157, or the aforementioned compounds of the Formula (I), which have a crystallization inhibitor effect. If desired, the nanoparticles formed, or the gel, may be dewatered to the paste state or even to the dry powder state. It is of course also possible to use commercially customary substances present in solid form. The solids prepared as described above or obtainable in commercially customary fashion may be subjected to a further comminuting operation, such as a wet deagglomeration. The liquid selected may be water or an organic liquid, such as an alcohol, a hydrocarbon or a halocarbon or halogenated hydrocarbon. The deagglomeration, which can be carried out in, for example ball mills, vibratory mills, agitator-mechanism mills, planetary ball mills or dissolvers with glass spheres, takes place in that case in the presence of a dispersant. The comminuting operation is usually performed in the presence of a solvent in a mill, preferably a ball mill such as a bead mill or a dissolver with glass spheres. A process of this kind is described in DE-A 198 32 304. In that case the particles and the dispersant are placed in a grinding vessel with loose grinding media and are comminuted to the desired fineness and mixed. Carbon dioxide ice or deep-cooled 1,1,1,2-tetrafluoroethane or similar substances are used as grinding assistants. Examples of suitable mills include ball mills, vibratory mills, agitator-mechanism mills and planetary ball mills. In these systems particle sizes of even below 20 nm are attained.

The dispersants have been specified above; by way of example it is possible to use an agent of the Formula (I) which has a crystallization inhibitor effect and also has dispersing properties. Where this agent has already been used in generating the solid particles, its crystallization inhibitor properties are exploited in the precipitation. For the deagglomeration it is preferred to use those of the abovementioned dispersants which contain at least one polyether or polyester based side chain and which therefore prevent reagglomeration sterically. Especially, those dispersants contain OH, NH, NH₂, SH, O—O peroxo, C—C double bond or 4-oxybenzonphenone propylphosphonate groups which will act as anchors for the polymer matrix. The groups used for coupling to or into polymers can be preferentially selected with regard to the nature of the polymer matrix. The comminution is continued until the desired degree of fineness has been attained. Comminution is preferably continued until the nanoparticles comprise primary and/or secondary particles having an average particle size of less than 0.5 μm, with particular preference less than 250 nm, with very particular preference less than 200 nm. More preferably still, deagglomeration is carried out until the secondary particles have an average particle size of less than 130 nm, with particular preference less than 100 nm, with very particular preference less than 80 nm, more preferably still <50 nm. These nanoparticles may partly or even substantially entirely be in the form of unagglomerated primary particles. The average particle size is determined by means of XRD or laser diffraction methods. Comminution forms a dispersion of nanoparticles in the solvent employed. This dispersion can then be used as it is, for incorporation into plastics, for example. As described later on below, the dispersion can also be used as an intermediate in the production of redispersible nanoparticles.

The second embodiment of the preparation of the nanoparticles envisages carrying out the production of the solid itself, by precipitation in the presence of a dispersant, for example; this procedure is able to lead, as early as during the precipitation, to the formation of deagglomerated nanoparticles which are readily redispersible. Dispersants of this kind, which endow the particles with a surface which prevents reagglomeration and inhibits agglomeration during the precipitation electrostatically, sterically or both electrostatically and sterically, have been elucidated early on above. This embodiment produces deagglomerated nanoparticles as early as during the precipitation stage. The dispersion of the nanoparticles in the solvent that is formed in this case can also be used as it is, in order for example to incorporate nanoparticles into a plastic or into a precursor of the plastic, such as into a prepolymer which is not yet fully polymerized or into reactants which then form the polymer by means, for example of polycondensation.

The dispersant is advantageously tailored to the solvent in which the respective nanoparticles are to be dispersed. Dispersants having relatively hydrophobic properties are used advantageously for the preparation of dispersions in apolar solvents or solvents having a low polarity.

An example of a dispersant suitable for the preparation of nanoparticle dispersions in solvents of low to zero polarity is represented by phosphoric esters which contain side chains with polyether fractions from ethylene oxide units, examples being those in which one oxygen atom of the P(O) group is substituted by a C3-C10 alkyl or alkenyl radical and a further oxygen atom of the P(O) group is substituted by a polyether side chain. A further acidic oxygen atom of the P(O) group is able to interact with the strontium carbonate surface. Dispersants of this kind are available from, for example, BYK CHEMIE under the designation Disperbyk® 102, 106 and 111. Solvents with a polarity of low to zero have already been mentioned above; methylene chloride is particularly good. Examples which are especially useful include linear ketones such as methyl ethyl ketone, esters of carboxylic acids having for example a total of 2 to 6 carbon atoms and alcohols having 1 to 4 carbon atoms, hydrocarbons or mixtures thereof such as special-boiling-point spirit (having boiling points of 21 to 55° C., 55 to 100° C., and with a boiling point above 100° C.), solvent naphtha or halogenated hydrocarbons such as methylene chloride.

Other dispersants bring about ready dispersibility of the nanoparticles in polar or protic solvents such as water, or alcohols such as isopropanol or n-butanol. An example is a polymer containing anionic groups which are able to interact with the surface of the strontium carbonate, examples being the groups mentioned above, and is substituted by polar groups, such as by hydroxyl groups or amino groups. Preferably there are polyether or polyester based side chains present which are terminally substituted by hydroxyl groups. As a result of this substitution the nanoparticles are externally hydrophilicized. Nanoparticles of this kind are readily dispersible and provide stable dispersions in polar or protic solvents. In the course of the application there may even be further deagglomeration.

Other interesting anchor groups for the polymer matrix are SH, O—O peroxo, C—C double bond or 4-oxybenzonphenone propylphosphonate groups. The groups used for coupling to or into polymers can be preferentially selected with regard to the nature and polarity of the polymer matrix. The polar groups, especially hydroxyl groups and amino groups represent reactive groups suitable for coupling to or into corresponding plastics, such as into epoxy resins in particular. Especially good properties are exhibited by a strontium carbonate coated with a dispersant which contains a multiplicity of polycarboxylate groups and a multiplicity of hydroxyl groups and also further substituents which are sterically bulky, examples being polyether or polyester based side chains. An especially preferred group of dispersants for nanoparticles used as fillers in epoxy resins are polyether polycarboxylates substituted terminally on the polyether based side chains by hydroxyl groups. Hydroxyl groups are also notably suitable for coupling to or into polyurethanes. Hydroxyl groups and thiol groups can be used for coupling to or into polyvinylchloride (PVC). 4-oxybenzophenone propylphosphonate can mainly be used for coupling to or into polyolefines or PVC. O—O peroxo groups are usually useful for unsaturated polyester or polyolefines. A last example is the use of C—C double bond for coupling to or into unsaturated polyesters.

The dispersion of the nanoparticles in the solvent that is obtained after the intense comminution can also be used as an intermediate for the production of redispersible powder from nanoparticles containing dispersant. If the solvent used in the course of the intense comminution is in fact removed, by spray-drying or evaporation at elevated temperature and/or reduced pressure, for example, then a dispersant-comprising nanopowder is formed which even without great energy input in a solvent, in a plastic present in liquid form and optionally diluted with solvent, in a polymeric precursor or an adhesive, can be converted again into a dispersion of nanoparticles that in terms of its particle properties, corresponds to the dispersion originally produced. The present invention therefore also relates to dry powders redispersible to deagglomerated nanoparticles, obtainable by drying a dispersion obtained according to the invention. Such redispersible nanopowders can be obtained by removing the solvent from the dispersion.

The powder obtained following intense comminution and removal of the solvent forms agglomerates which are loose at best, and which are redispersible in liquid media and in the course of their redispersion form deagglomerated particles again. If the especially preferred polymeric dispersants are employed which prevent reagglomeration sterically and contain polar groups for coupling to or into polymers, then renewed dispersion is accompanied indeed by observation of a further deagglomeration on the part of the nanoparticles.

The nanoparticles in the present invention are salts of metals. Preference is given to those salts of metals that have a low solubility in water and/or organic solvents. “Low solubility” means preferably at less than 1 g/l, preferably less than 0.1 g/l dissolves at room temperature (20° C.). Especially preferred salts are those which exhibit low solubility in water and in organic solvents.

Preferred cations are selected from main group 1 of the Periodic Table of the Elements, particular preference being given to Cu, Ag and Au; from main groups 2 and 3 of the Periodic Table of the Elements, particular preference being given to Mg, Ca, Sr, Ba, Zn, Al and In; from main group 4 of the Periodic Table of the Elements, particular preference attaching to Ti, Zr, Si, Ge, Sn and Pb; and from main group 6 of the Periodic Table of the Elements, preferably Cr and W. Particularly preferred cations are also metals from the transition groups of the Periodic Table of the Elements, including the lanthanoid metals. The invention also relates to mixtures of such cations.

Preferred anions are PO₄³⁻, SO₄²⁻, CO₃²⁻, F⁻, O²⁻ and OH⁻. These also include salts having two or more of these anions, such as oxyfluorides, and also hydrates of salts and mixtures thereof.

Especially preferred fillers used are SrSO₄, MgCO₃, CaCO₃, BaCO₃, SrCO₃, Zn₃(PO₄)₂, Ca₃(PO₄)₂, Sr₃(PO₄)₂, Ba₃(PO₄)₂, Mg₂(PO₄)₂, SiO₂, Al₂O₃, MgF₂, CaF₂, BaF₂, SrF₂, TiO₂, ZrO₂, fluorides and oxyfluoraides of lanthanoid metals and also alkali metal and alkaline earth metal fluorometallate and mixtures thereof, such as BaSO₄/CaCO₃ mixture. An example of mixed salt is Ba/TiO₃. German patent application No. 102004039485.7, unpublished at the priority date of the present specification, discloses dispersions of rod-shaped strontium carbonate in halogenated solvents. The subject matter disclosed therein is excluded from the scope of protection, insofar as is relevant in patent law.

The nanoparticles can be used for those purposes for which nanoparticles are typically used. They are especially suitable as a filler for plastics.

The nanoparticles, present in the form of readily redispersible powder or of an aqueous dispersion or of a dispersion in an organic solvent, are likewise provided by the invention and can be used for all purposes for which nanoparticles are typically used, for example as fillers in plastics such as plastomers and elastomers, adhesives and sealants. Where appropriate, the redispersable nanoparticles can be first redispersed as a dispersion.

Coatings which comprise nanoparticles, especially silica-based or alumina-based nanoparticles, are well established. Reference is made by way of example to patent applications EP 1 179 575 A2, WO 00/35599 A, WO 99/52964 A, WO 99/54412 A, WO99/52964 A, DE 197 26 829 A1 or DE 195 40 623 A1. They serve in particular for producing highly scratch-resistant coatings.

The deagglomerated nanoparticles are suitable not only as an additive for the coatings above, but also, generally, as an additive notably for plastics, examples being saturated and unsaturated polyolefines, PVC, phenolic resins, acrylic resins, alkyd resins, epoxy resins, saturated and unsaturated polyesters, polyurethanes, silicone resins, urea resin and melamine resin, polycarbonate and polyamide resin. Plastics with added nanoparticles of the invention are likewise provided by the invention. The amount of nanoparticles in the plastic is advantageously 1% to 50% by weight, preferably 1% to 25% by weight.

For example, it has been found that nanoparticles of the invention, especially those comprising—where appropriate in addition to a crystallization inhibitor—a polymeric polyether polycarboxylate dispersant substituted terminally on the ether groups by hydroxyl groups and so rendered hydrophilic, can be used suitable to particularly good effect for application in epoxy mouldings or epoxy resins and also corresponding composite materials. Epoxy resins are used for example as casting resins or else as laminates (in aircraft, vehicle or water craft construction, for example).

An elucidation of principles is found for example in Ullmanns Enzyklopädie der Technischen Chemie, 4th edition, Volume 10, pages 563-580 and in Kirk-Othmer, Encyclopedia of Chemical Technology, 4th edition, volume 9, pages 730-755.

One advantageous method of incorporating the nanoparticles into a plastic composition envisages first producing a dispersion in a suitable solvent, introducing this dispersion into the plastic and then evaporating off the solvent. The plastic itself may be in solution in a solvent. The dispersion can also be introduced into a polymeric precursor, such as a reactant. The dispersion of the nanoparticles in the solvent can be mixed with the plastic or with the precursor of the plastic in a mixing apparatus or vessel equipped with a stirrer mechanism. It is also possible to raise the temperature in order to lower the viscosity. After mixing has taken place, the solvent is evaporated off, usually by increasing the temperature and/or by application of a vacuum. Hence the barium sulphate is in dispersion in the plastic or the precursor of the plastic.

The solvent is selected with regard to the intended application. It must be compatible with the plastic or with the plastics precursor: for example, it must not exhibit unwanted reaction, and it must be sufficiently soluble therein. Suitable solvents are also preferably chosen in view of the polymer polarity. Examples of suitable solvents notably include alkanols or diols, such as propanol, isopropanol or n-butanol; ethers, such as diethylether, tetrahydrofuran or ethers of glycol; carboxylic esters, such as ethyl acetate; ketones such as acetone, methyl ethyl ketone or cyclopentanone; hydrocarbons, such as solvent naphta; halogenated organic solvents, such as dichloromethane or o-dichlorobenzene; or mixture thereof.

This method is notably very suitable for incorporating nanoparticles into hydrophobic plastics, such as polycarbonate or PVC, by mixing a dispersion of the nanoparticles in a low polarity solvent, such as halogenated organic solvents, ethers or esters, with the plastic or precursors thereof, then evaporating off the solvent. Another example is the use of a dispersion of nanoparticles in acetone or o-dichlorobenzene for incorporation into unsaturated polyester resin. This method is also very suitable for incorporating nanoparticles into epoxy resins, using a dispersion of the nanoparticles in a polar solvent. The dispersion of the nanoparticles can also be added to the epoxy resin precursors This method is also very suitable for incorporating nanoparticles into a polyurethane by mixing the alcoholic dispersion with the diol, evaporating off the alcoholic solvent, and further reacting the nanoparticle-containing diol with an isocyanate component.

By means of the invention, it is possible to generate nanoparticles which, following their production and comminution to nanoparticles, and subsequent removal of the solvent, are redispersible without the need for a further intense comminuting operation such as treatment in a bead mill. The deagglomerated nanoparticles have very small particle sizes, with an average diameter for example of 60 to 80 nm. This means that the deagglomeration is very effective, and, in particular, this particle size is achieved again by simple mixing of the particles, which have once passed through a deagglomeration stage, in solvents, in the plastic, in the adhesive or in the polymeric precursor; the particles, therefore, can be redispersed very well without any need to insert a further deagglomeration stage. The dispersion of the nanoparticles, especially in organic solvents, lends itself well to incorporation into plastics, their solutions or prepolymers or the reactants used to produce the plastics. It is possible to produce transparent plastics. The plastics feature high scratch resistance and impact strength. Adhesives comprising the nanoparticles have enhanced cohesion in tandem with unaffected adhesion.

The examples which follow are intended to illustrate the invention without restricting it in its scope.

### EXAMPLES

### Example 1

### Production of Dispersions of Nanoparticles

General indications on implementation:

The material to be converted into dispersed nanoparticles is admixed with 10% by weight of the dispersant, based on the dry weight of said material. It is then dispersed with the solvent in a bead mill until the desired fineness has been attained; this takes about 10 to 20 minutes. The solids content is approximately 50% by weight, based on the total weight of the dispersion.

The BaCO₃ employed contained crystallization inhibitor. The fluorides were prepared from the corresponding carbonates and hydrofluoric acid.

The following dispersions can be prepared by way of example in this way:

| Solid | Dispersant¹ | Solvent |
|---|---|---|
| SrSO₄ | Melpers 0030 | isopropanol |
| SrSO₄ | DISPERBYK 102 | CH₂Cl₂ |
| SrSO₄ | DISPERBYK 102 | cyclopentanone |
| BaCO₃ | DISPERBYK 102 | cyclopentanone |
| Sr₃(PO₄)₂ | Melpers 0030 | isopropanol |
| MgF₂ | Melpers 0030 | isopropanol |
| MgF₂ | DISPERBYK 102 | CH₂Cl₂ |
| BaF₂ | Melpers 0030 | isopropanol |
| TiO₂ | Melpers 0030 | isopropanol |
| TiO₂ | DISPERBYK 102 | cyclopentanone |
| CaF₂ | Melpers 0030 | isopropanol |
| CaF₂ | DISPERBYK 102 | cyclopentanone |

¹Melpers ® 0030 is a polyether polycarboxylate substituted terminally on the polyether groups by hydroxyl groups. DISPERBYK ® 102 is a phosphoric ester salt with polyether/alkyl side chains.

### Example 2

### Production of Nanopowder from the Dispersions in Example 1

The dispersions of Example 1 are freed from the solvent under reduced pressure, giving a powder containing 10% by weight dispersant.

### Example 3

### Production of Dispersions By Redispersion of the Powder from Example 2

The powder from Example 2 is admixed with the same solvent originally used to produce it. Redispersion is carried out in a dissolver without glass spheres. It is found that the powder constituents in the solvent form a dispersion again, the particle size of the dispersed particles corresponding to the size of the particles in the dispersion produced beforehand in the bead mill. Consequently the nanopowders of the invention are outstandingly redispersible.

It is also possible to carry out the redispersion in cyclopentanone if the original dispersion is based on dichloromethane.

### Example 4

### Production of Finely-Divided Barium Carbonate By Precipitation in the Presence of Crystallization Inhibitors

Barium carbonate is precipitated as described in WO 01/49609, using a citric acid as crystallization inhibitor, and dried. The barium carbonate obtained is then dispersed as described in Example 1 using Melpers 0030 and isopropanol in a bead mill. The solvent is evaporated off to give a nanoparticle powder which when redispersed in propanol gives a dispersion comparable with the original dispersion.

1-31. (canceled)

32. Nanoparticles coated with a dispersant and optionally comprising a crystallization inhibitor, said nanoparticles having an average particle size <500 nm with the exception of barium sulphate particles.

33. The nanoparticles according to claim 32, comprising primary and secondary nanoparticles, the secondary nanoparticles having an average particle size of smaller than 2000 nm.

34. The nanoparticles according to claim 32, wherein the crystallization inhibitor is present and is selected from compounds comprising at least one anionic group, the anionic group being selected from sulphate, sulphonate, phosphate, phosphonate, carboxylate group(s), and mixtures thereof.

35. The nanoparticles according to claim 32, wherein the crystallization inhibitor is present and is a compound of the formula (I) or a salt thereof having a carbon chain R and n substituents [A(O)OH],
R[-A(O)OH]ₙ (I)
in which R is an organic radical which has hydrophobic and/or hydrophilic moieties, R being a low molecular mass, oligomeric or polymeric, optionally branched and/or cyclic carbon chain which optionally comprises oxygen, nitrogen, phosphorus or sulphur heteroatoms and/or is substituted by radicals which are attached via oxygen, nitrogen, phosphorus or sulphur to the radical R, A being C, P(OH), OP(OH), S(O) or OS(O), and n being 1 to 10,000.

36. The nanoparticles according to claim 32, wherein the crystallization inhibitor is present and is an optionally hydroxy-substituted carboxylic acid having at least two carboxylate groups; an alkyl sulphate; an alkylbenzenesulphonate; a polyacrylic acid; a polyaspartic acid; an optionally hydroxy-substituted diphosphonic acid; ethylenediamine or diethylenetriamine derivatives comprising at least one carboxylic acid or phosphonic acid and optionally substituted by hydroxyl groups; or salts thereof.

37. The nanoparticles according to claim 32, wherein the dispersant comprises anionic groups which are able to interact with the surface of the nanoparticles, the anionic groups being selected from carboxylate, phosphate, phosphonate, bisphosphonate, sulphate, and sulphonate groups.

38. The nanoparticles according to claim 37, wherein the dispersant comprises one or more organic radicals R¹, which have hydrophobic and/or hydrophilic moieties.

39. The nanoparticles according to claim 38, wherein R¹ is a low molecular mass, oligomeric or polymeric, optionally branched and/or cyclic carbon chain which optionally comprises oxygen, nitrogen, phosphorus or sulphur heteroatoms and/or is substituted by radicals which are attached via oxygen, nitrogen, phosphorus or sulphur to the radical R¹ and the carbon chain is optionally substituted by hydrophilic or hydrophobic radicals.

40. The nanoparticles according to claim 39, wherein the dispersant is a phosphoric diester having a polyether based side chain and a C6-C10 alkenyl group as moieties.

41. The nanoparticles according to claim 38, wherein the dispersant comprises at least one group for coupling to or into polymers, selected from OH, NH, NH₂, SH, O—O peroxo, C—C double bond, or 4-oxybenzophenone propylphosphonate groups.

42. The nanoparticles according to claim 41, wherein the dispersant comprises at least one polyether or polyester based side chain.

43. The nanoparticles according to claims 42, wherein the polyether or polyester based side chains comprise groups for coupling to or into polymers.

44. The nanoparticles according to claim 43, wherein the hydroxyl groups and amino groups function as reactive groups for coupling to or into epoxy resins.

45. The nanoparticles according to claim 43, wherein the dispersant is a polyether polycarboxylate which is substituted terminally on the polyether groups by hydroxyl groups.

46. The nanoparticles according to claim 32, wherein the crystallization inhibitor and the dispersant are each present in an amount of up to 2 parts by weight per part by weight of nanoparticles, said nanoparticles comprising at least one dispersant, and the sum of the crystallization inhibitor and the dispersant is not greater than 80% by weight of the total weight of the nanoparticles.

47. The nanoparticles according to claim 32, wherein said nanoparticles are metal salts whose cations are selected from main groups 1 of the Periodic Table of the Elements, from main groups 2 and 3 of the Periodic Table of the Elements, from main group 4 of the Periodic Table of the Elements, from main group 6 of the Periodic Table of the Elements, and from the transition groups of the Periodic Table of the Elements, including the lanthanoid metals.

48. The nanoparticles according to claim 47, wherein said nanoparticles have a solubility in water and/or organic solvents of less than 1 g/l at room temperature (20° C.).

49. The nanoparticles according to claim 48, wherein the cations are selected from Cu, Ag, Au, Ti, Zr, Si, Ge, Cr, W, Si, Ge, Sn, Pb, Mg, Ca, Sr, Ba, Zn, In and Al and mixtures thereof.

50. The nanoparticles according to claim 32, wherein said nanoparticles are metal salts whose anions are selected from PO₄³⁻, SO₄²⁻, CO₃²⁻, F, O²⁻ and OH—, including nanoparticles having two or more of these anions such as oxyfluorides and also hydrates and mixtures thereof.

51. The nanoparticles according to claim 32, wherein said nanoparticles are selected from SrSO₄, MgCO₃, CaCO₃, BaCO₃, SrCO₃, Zn₃(PO₄)₂, Ca₃(PO₄)₂, Sr₃(PO₄)₂, Ba₃(PO₄)₂, Mg₂(PO₄)₂, SiO₂, Al₂O₃, MgF₂, CaF₂, BaF₂, SrF₂, TiO₂, ZrO₂, fluorides and oxyfluorides of lanthanoid metals and also alkali metal and alkaline earth metal fluorometallates and mixtures thereof.

52. A dispersion of nanoparticles of claim 32 in water, in an organic liquid or a mixture of water and organic liquid, with the exception of dispersions of rod-shaped strontium carbonate in halogenated solvents as disclosed in German patent application No. 102004039485.7 unpublished at the priority date of the present application.

53. The dispersion according to claim 52, wherein the nanoparticles are present in the dispersion in an amount of 0.1 up to 70% by weight.

54. A dry powder redispersible to deagglomerated nanoparticles, obtained by drying a dispersion according to claim 53.

55. A process for producing nanoparticles of claim 32, comprising converting chemical compounds corresponding to the nanoparticles into a solid form in the presence of the dispersant.

56. A process for producing nanoparticles of claims 32, comprising subjecting chemical compounds corresponding to the nanoparticles, which are present in particulate form larger than desired, to an intensive an intensive comminuting operation in the presence of the dispersant.

57. The process according to claim 56, wherein the comminuting operation is performed in the presence of a solvent in a mill.

58. A filler comprising nanoparticles according to claim 32 in the form of an aqueous dispersion, a dispersion in an organic solvent, or a powder.
